(19) United States
(12) Patent Application Publication
(10) Pub. No.: US 2026/0089033 A1
(43) Pub. Date: Mar. 26, 2026

(54) COMMUNICATION METHOD AND COMMUNICATION APPARATUS

(71) Applicant: Huawei Technologies Co., Ltd., Shenzhen (CN)

(72) Inventors: Xiaoyan Bi, Shanghai (CN); Jianglei Ma, Ottawa (CA); Yiqun Ge, Ottawa (CA); Wuxian Shi, Ottawa (CA)

(21) Appl. No.: 19/409,561

(22) Filed: Dec. 4, 2025

Related U.S. Application Data
(63) Continuation of application No. PCT/CN2023/117565, filed on Sep. 7, 2023.
(60) Provisional application No. 63/506,716, filed on Jun. 7, 2023.

(51) Int. Cl. H04L 25/02; H04L 27/26

(52) U.S. Cl. CPC H04L 25/0232; H04L 27/261

(57) ABSTRACT

Embodiments of the present application provide a communication method and a communication apparatus. The method includes: a receiving apparatus receives indication information, where the indication information indicates that assistance information is for channel estimation or channel interpolation; the receiving apparatus receives reference signals; and the receiving apparatus performs the channel estimation or channel interpolation based on the reference signals and the assistance information.

### CROSS-REFERENCE TO RELATED APPLICATIONS

This application is a continuation of International Application No. PCT/CN2023/117565, filed on Sep. 7, 2023, which claims priority to U.S. provisional Patent Application No. 63/506,716, filed on Jun. 7, 2023. The disclosures of the aforementioned applications are hereby incorporated by reference in their entireties.

### TECHNICAL FIELD

Embodiments of the present application relate to the field of communications, and more specifically, to a communication method and a communication apparatus.

### BACKGROUND

In a wireless communication system, to implement functions such as system synchronization, channel information feedback, and data transmission, a channel construct operation, such as channel estimation and channel interpolation, needs to be performed on an uplink channel or a downlink channel.

For performing the channel construct operation, reference signals could be transmitted between a receiving apparatus and a transmitting apparatus. How the reference signals are used to perform the channel construct operation is an urgent problem to be solved.

### SUMMARY

Embodiments of the present application provide a communication method and a communication apparatus. The technical solutions may make a channel construct operation more flexible.

According to a first aspect, an embodiment of the present application provides a communication method, and the method could be performed by a receiving apparatus. The receiving apparatus is a communication device (for example, a base station or a UE) or a chip in the communication device. The method includes: receiving indication information, where the indication information indicates that assistance information is for channel estimation; receiving reference signals; and performing the channel estimation based on the reference signals and the assistance information.

According to the above technical solution, a transmitting apparatus could indicate that assistance information is for channel estimation, and the receiving apparatus could perform the channel estimation based on the reference signals and the assistance information. The process that the receiving apparatus performs the channel estimation indicated by the transmitting apparatus based on the reference signals and the assistance information makes the channel estimation more flexible.

According to a second aspect, an embodiment of the present application provides a communication method, and the method could be performed by a receiving apparatus. The receiving apparatus is a communication device (for example, a base station or a UE) or a chip in the communication device. The method includes: receiving indication information, where the indication information indicates that assistance information is for channel interpolation; receiving reference signals; and performing the channel interpolation based on the reference signals and the assistance information.

According to the above technical solution, a transmitting apparatus could indicate that assistance information is for channel interpolation, and the receiving apparatus could perform the channel interpolation based on the reference signals and the assistance information. The process that the receiving apparatus performs the channel interpolation indicated by the transmitting apparatus based on the reference signals and the assistance information makes the channel interpolation more flexible.

In a possible design, the indication information is implemented by using one or more bits.

According to the above technical solution, the receiving apparatus could explicitly determine that the assistance information is for channel interpolation or channel estimation.

In a possible design, the indication information includes a first parameter set of the assistance information, and the first parameter set has a relationship with the channel estimation.

In a possible design, the indication information includes a first parameter set of the assistance information, and the first parameter set has a relationship with the channel interpolation.

According to the above technical solution, the receiving apparatus could determine the assistance information is for channel interpolation or channel estimation based on the first parameter set of the assistance information and the relationship.

In a possible design, the first parameter set includes one or more of the following: a type of the assistance information, and a dimension of the assistance information.

In a possible design, the indication information includes a second parameter set of the reference signals, and the second parameter set has a relationship with the channel estimation.

In a possible design, the indication information includes a second parameter set of the reference signals, and the second parameter set has a relationship with the channel interpolation.

According to the above technical solution, the receiving apparatus could determine the assistance information is for channel interpolation or channel estimation based on the second parameter set of the assistance information and the relationship.

In a possible design, the second parameter set includes one or more of the following: a pattern density of the reference signals, and a type of the reference signals.

In a possible design, the indication information is determined based on UE capability.

In a possible design, the method further includes: transmitting capability information indicating the UE capability.

In a possible design, the method further includes: receiving the assistance information.

According to a third aspect, an embodiment of the present application provides a communication method, and the method could be performed by a transmitting apparatus. The transmitting apparatus is a communication device (for example, a base station or a UE) or a chip in the communication device. The method includes: transmitting indication information, where the indication information indicates that assistance information is for channel estimation; and transmitting reference signals for the channel estimation.

According to a fourth aspect, an embodiment of the present application provides a communication method, and the method could be performed by a transmitting apparatus. The transmitting apparatus is a communication device (for example, a base station or a UE) or a chip in the communication device. The method includes: transmitting indication information, where the indication information indicates that assistance information is for channel interpolation; and transmitting reference signals for the channel interpolation.

In a possible design, the indication information is implemented by using one or more bits.

In a possible design, the indication information includes a first parameter set of the assistance information, and the first parameter set has a relationship with the channel estimation.

In a possible design, the indication information includes a first parameter set of the assistance information, and the first parameter set has a relationship with the channel interpolation.

In a possible design, the first parameter set includes one or more of the following: a type of the assistance information, and a dimension of the assistance information.

In a possible design, the indication information includes a second parameter set of the reference signals, and the second parameter set has a relationship with the channel estimation.

In a possible design, the indication information includes a second parameter set of the reference signals, and the second parameter set has a relationship with the channel interpolation.

In a possible design, the second parameter set includes one or more of the following: a pattern density of the reference signals, and a type of the reference signals.

In a possible design, the indication information is determined based on UE capability.

In a possible design, the method further includes: receiving capability information indicating the UE capability.

In a possible design, the method further includes: transmitting the assistance information.

In a possible design, the method further includes: receiving channel measurement results, and the channel measurement results are determined based on the reference signals and the assistance information.

For an example, the indication information indicates that the assistance information is for channel estimation, and the channel measurement results include channel estimation results.

For another example, the indication information indicates that the assistance information is for channel interpolation, and the channel measurement results include channel interpolation results.

According to a fifth aspect, an embodiment of the present application provides a communication method, and the method could be performed by a receiving apparatus. The receiving apparatus is a communication device (for example, a base station or a UE) or a chip in the communication device. The method includes: receiving indication information, where the indication information indicates that assistance information is for a channel construct operation; receiving reference signals; and performing the channel construct operation based on the reference signals and the assistance information.

In a possible design, the channel construct operation includes channel estimation and/or channel interpolation.

In a possible design, the indication information is implemented by using one or more bits.

In a possible design, the indication information includes a first parameter set of the assistance information, and the first parameter set has a relationship with the channel construct operation.

In a possible design, the first parameter set includes one or more of the following: a type of the assistance information, and a dimension of the assistance information.

In a possible design, the indication information includes a second parameter set of the reference signals, and the second parameter set has a relationship with the channel construct operation.

In a possible design, the second parameter set includes one or more of the following: a pattern density of the reference signals, and a type of the reference signals.

In a possible design, the indication information is determined based on UE capability.

In a possible design, the method further includes: transmitting capability information indicating the UE capability.

In a possible design, the method further includes: receiving the assistance information.

According to a sixth aspect, an embodiment of the present application provides a communication method, and the method could be performed by a transmitting apparatus. The transmitting apparatus is a communication device (for example, a base station or a UE) or a chip in the communication device. The method includes: transmitting indication information, where the indication information indicates that assistance information is for channel construct operation; and transmitting reference signals for the channel construct operation.

In a possible design, the channel construct operation includes channel estimation and/or channel interpolation.

In a possible design, the indication information is implemented by using one or more bits.

In a possible design, the indication information includes a first parameter set of the assistance information, and the first parameter set has a relationship with the channel construct operation.

In a possible design, the first parameter set includes one or more of the following: a type of the assistance information, and a dimension of the assistance information.

In a possible design, the indication information includes a second parameter set of the reference signals, and the second parameter set has a relationship with the channel construct operation.

In a possible design, the second parameter set includes one or more of the following: a pattern density of the reference signals, and a type of the reference signals.

In a possible design, the indication information is determined based on UE capability.

In a possible design, the method further includes: receiving capability information indicating the UE capability.

In a possible design, the method further includes: transmitting the assistance information.

In a possible design, the method further includes: receiving channel measurement results, and the channel measurement results are determined based on the reference signals and the assistance information.

Various implementations of the third aspect to the sixth aspect correspond to various implementations of the first aspect and the second aspect. For the various implementations and the beneficial technical effects of the various implementations of the third aspect to the sixth aspect, reference may be made to the descriptions of the relevant implementations of the first aspect and second aspect, which will not be repeated here.

According to a seventh aspect, a communication apparatus is provided, and configured to perform the method in any possible implementation of the foregoing aspects. Specifically, the apparatus includes a unit configured to perform the method in any possible implementation of the foregoing aspects.

According to an eighth aspect, another communication apparatus is provided, including a processor. The processor is coupled to a memory, and may be configured to execute one or more instructions in the memory, to implement the method in any possible implementation of the various aspects. The memory may be an on-chip storage unit inside the processor, or may be an off-chip storage unit that is coupled to the memory and located outside the processor. In a possible implementation, the apparatus further includes the memory. In a possible implementation, the apparatus further includes a communication interface, and the processor is coupled to the communication interface.

In a possible design, the communication apparatus may be a transmitting apparatus (for example, a network device or a user equipment), may be a chip, a circuit, or a processing system configured in the transmitting apparatus, or may be a device including the transmitting apparatus.

In a possible design, the communication apparatus may be a receiving apparatus (for example, a network device or a user equipment), may be a chip, a circuit, or a processing system configured in the receiving apparatus, or may be a device including the receiving apparatus.

According to a ninth aspect, a computer-readable storage medium is provided. The computer-readable storage medium stores a computer program, and when the computer program is executed by a communication apparatus, the communication apparatus is enabled to implement the method in any possible implementation of the foregoing aspects.

According to a tenth aspect, a computer program product including one or more instructions is provided. When the instructions are executed by a computer, a communication apparatus is enabled to implement the method in any possible implementation of the foregoing aspects.

According to an eleventh aspect, a communication system is provided, including the foregoing transmitting apparatus and the foregoing receiving apparatus.

### DESCRIPTION OF THE DRAWINGS

FIG. 1 is a schematic diagram of an application scenario according to this application;

FIG. 2 illustrates an example communication system 100;

FIG. 3 illustrates another example of an electronic device (ED) 110 and a base station 170a, 170b and/or 170c;

FIG. 4 is an example of a channel model of a multiple-input multiple-output (MIMO) system;

FIG. 5 is an example of a process in which the base station obtains channel state information (CSI);

FIG. 6 is an example of channel estimation and channel interpolation;

FIG. 7 is a schematic flowchart of a communication method 700 according to an embodiment of this application;

FIG. 8 is a schematic block diagram of a communication apparatus according to an embodiment of this application;

FIG. 9 is a schematic block diagram of another communication apparatus according to an embodiment of this application;

FIG. 10 is a flow chart of embodiment 1;

FIG. 11 is a flow chart of embodiment 2;

FIG. 12 is a flow chart of embodiment 3; and

FIG. 13 illustrates units or modules in a device.

### DETAILED DESCRIPTION OF THE ILLUSTRATIVE EMBODIMENTS

The following describes technical solutions of the present application with reference to the accompanying drawings.

The technical solutions in embodiments of this application may be applied to multiple-input multiple-output (MIMO) technology. And the technical solutions in embodiments of this application may be applied to various communication systems, such as a fifth generation (5G) wireless communication system, a new ratio (NR) wireless communication system, a Long Term Evolution (LTE) system, an LTE frequency division duplex (FDD) system, an LTE time division duplex (TDD) system, a wireless local area network (WLAN), a satellite communication system, or other evolving communication systems, such as a sixth generation (6G) wireless communication system.

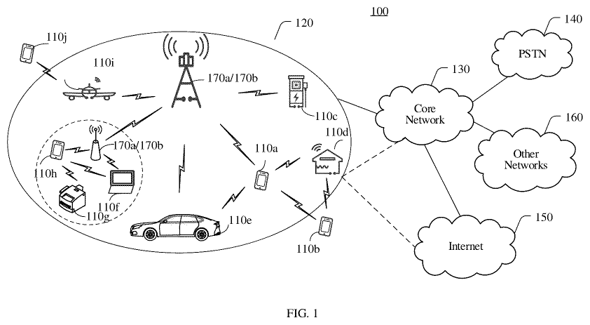

For ease of understanding of the embodiments of this application, a communication system shown in FIG. 1-FIG. 3 is used as an example to describe in detail a communication system to which the embodiments of this application are applicable.

Referring to FIG. 1, as an illustrative example without limitation, a simplified schematic illustration of a communication system is provided. The communication system 100 includes a radio access network 120. The radio access network 120 may be a next generation (e.g. sixth generation (6G) or later) radio access network, or a legacy (e.g. 5G, 4G, 3G or 2G) radio access network. One or more communication electronic devices (ED) 110a-110j (generically referred to as ED 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the Internet 150, and other networks 160.

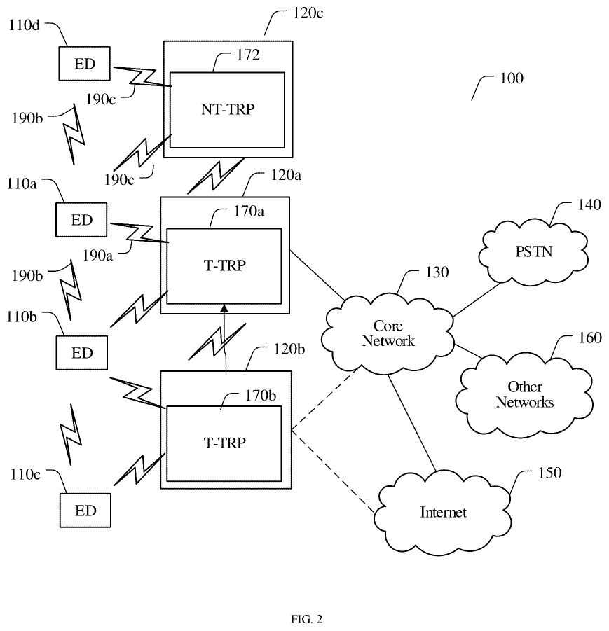

Referring to FIG. 2, an example communication system 100 is illustrated. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the Internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the Internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), and User Datagram Protocol (UDP). EDs 110a 110b, and 110c may be multimode devices capable of operation according to multiple radio access technologies, and incorporate multiple transceivers necessary to support such.

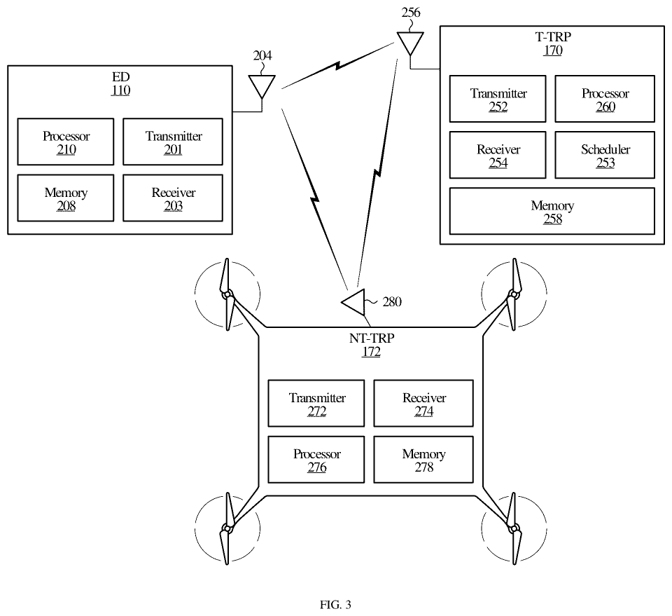

Referring to FIG. 3, another example of an ED 110 and a base station 170a, 170b and/or 170c is illustrated. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or an apparatus (e.g. a communication module, a modem, or a chip) in the forgoing devices, among other possibilities. Future generation EDs 110 may be referred to as other terms. The base station 170a and 170b is a T-TRP and will hereafter be referred to as T-TRP 170. Also, as shown in FIG. 3, an NT-TRP will hereafter be referred to as NT-TRP 172. Each ED 110 connected to T-TRP 170 and/or NT-TRP 172 can be dynamically or semi-statically turned on (i.e., established, activated, or enabled), turned off (i.e., released, deactivated, or disabled) and/or configured in response to one or more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmissions to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be reference signals transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations related to network access (e.g. initial access) and/or downlink synchronization, such as operations related to detecting a synchronization sequence, decoding and obtaining the system information, etc. In some embodiments, the processor 210 may perform channel estimation, e.g. using reference signals received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and the receiver 203 may each be implemented by the same or different one or more processors that are configured to execute instructions stored in a memory (e.g. in memory 208). Alternatively, some or all of the processor 210, and the processing components of the transmitter 201 and the receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), radio unit (RU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. a communication module, a modem, or a chip) in the foregoing devices.

The CU (or CU-control plane (CP) and CU-user plane (UP)), DU or RU may be known by other names in some implementations. For example, in an open RAN (ORAN) system, the CU may also be referred to as open CU (O-CU), DU may also be referred to as open DU (O-DU), CU-CP may also be referred to open CU-CP (O-CU-CP), CU-UP may also be referred to as open CU-UP (O-CU-CP), and RU may also be referred to open RU (O-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remotely from the equipment housing the antennas of the T-TRP 170, and may be coupled to the equipment housing the antennas over a communication link (not shown) sometimes known as front haul, such as a common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations related to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by a scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

The scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and executed by the processor 260.

Although not illustrated, the processor 260 may form part of the transmitter 252 and/or the receiver 254. Also, although not illustrated, the processor 260 may implement the scheduler 253. Although not illustrated, the memory 258 may form part of the processor 260.

The processor 260, the scheduler 253, and the processing components of the transmitter 252 and the receiver 254 may each be implemented by the same or different one or more processors that are configured to execute instructions stored in a memory, e.g. in memory 258. Alternatively, some or all of the processor 260, the scheduler 253, and the processing components of the transmitter 252 and the receiver 254 may be implemented using dedicated circuitry, such as an FPGA, a GPU, or an ASIC.

The NT-TRP 172 is illustrated as a drone only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and the receiver 274 may each be implemented by the same or different one or more processors that are configured to execute instructions stored in a memory, e.g. in memory 278. Alternatively, some or all of the processor 276 and the processing components of the transmitter 272 and the receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

For ease of understanding of the embodiments of this application, the following briefly describes several terms used in this application.

### 1) Multiple-Input Multiple-Output (MIMO)

MIMO technology allows an antenna array of multiple antennas to perform signal transmissions and receptions to meet high transmission rate requirements. The above ED 110 and T-TRP 170, and/or NT-TRP use MIMO to communicate over wireless resource blocks. MIMO utilizes multiple antennas at the transmitting apparatus and/or receiving apparatus to transmit the wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attention from the academia and the industry. In the large-scale MIMO system, the T-TRP 170 and/or NT-TRP 172 is generally configured with more than ten antenna units (such as 128 or 256), and serves for dozens of the ED 110. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase in the number of antennas allows each antenna unit to be made smaller and at a lower cost. Using the degree of spatial freedom provided by the large-scale antenna units, the T-TRP 170 and NT-TRP 172 of each cell can communicate with many EDs 110 in the cell on the same time-frequency resource at the same time, thus greatly increasing the spectrum efficiency. A large number of antenna units of the T-TRP 170 and/or NT-TRP 172 also enable each user to have better spatial directivity for uplink and downlink transmission, so that the transmitting power of the T-TRP 170 and/or NT-TRP 172 and an ED 110 is reduced, and the power efficiency is greatly increased. When the number of antennas of the T-TRP 170 and/or NT-TRP 172 is sufficiently large, random channels between each ED 110 and the T-TRP 170 and/or NT-TRP 172 can be close to be orthogonal, and the interference between the cell and the users and the effect of noises can be eliminated. The plurality of advantages described above enable the large-scale MIMO to have a magnificent application prospect.

A MIMO system may include a receiving apparatus connected to a receive (Rx) antenna, a transmitting apparatus connected to a transmit (Tx) antenna, and a signal processor connected to the transmitting apparatus and the receiving apparatus. Each of the Rx antenna and the Tx antenna may include a plurality of antennas. For instance, the Rx antenna may have a ULA antenna array in which the plurality of antennas are arranged in a line at even intervals. When a radio frequency (RF) signal is transmitted through the Tx antenna, the Rx antenna may receive a signal reflected and returned from a forward target. The receiving apparatus could be an ED (i.e. ED 110) and the transmitting apparatus could be a T-TRP or NT-TRP (i.e. T-TRP 170 or NT-TRP 172), or the receiving apparatus could be a T-TRP or NT-TRP (i.e. T-TRP 170 or NT-TRP 172) and the transmitting apparatus could be an ED (i.e. ED 110).

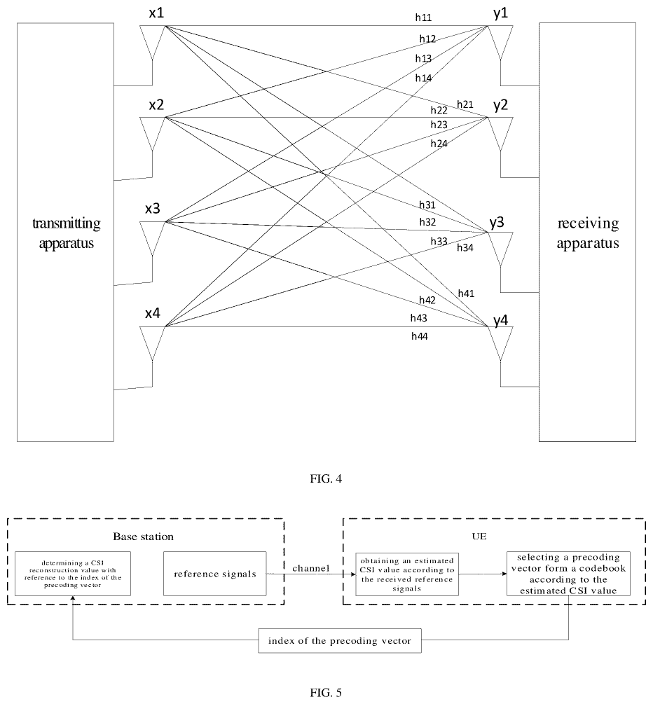

Referring to FIG. 4, as an illustrative example without limitation, a simplified schematic illustration of a communication scenario is provided. A transmitting apparatus is connected to four Tx antennas, x1 to x4, a receiving apparatus is connected to four Rx antennas, y1 to y4, and a transmission channel may be formed between each Tx antenna and each Rx antenna. For example, an RF signal transmitted through x1 may be received by y2 through channel h21. The RF signal transmitted through x3 may be received by y1 through channel h13.

Hereafter, a base station is used as an example of T-TRP 170 or NT-TRP 172, and the UE is used as an example of ED 110. A receiving apparatus may be referred to as ED 110 for a downlink transmission, and T-TRP 170 or NT-TRP 172 for an uplink transmission. A transmitting apparatus may be referred to as T-TRP 170 or NT-TRP 172 for a downlink transmission, and ED 110 for an uplink transmission. However, limitation is not made herein.

### 2) Channel Estimation

In a MIMO system, to implement functions such as system synchronization, channel information feedback, and data transmission, channel estimation needs to be performed on an uplink channel or a downlink channel. Channel estimation refers to the process of reconstructing or restoring received signals to compensate for signal distortion caused by channel fading and noise. In channel estimation, reference signals predicted by a transmitting apparatus and a receiving apparatus may be used to track a change in the time domain and/or frequency domain of a channel, so as to reconstruct or restore a received signal. The reference signals may also be referred to as a pilot signal, a reference sequence or the like, and are described as reference signals in the following for ease of understanding. The reference signal includes, for example, a channel state information-reference signal (CSI-RS), a sounding reference signal (SRS), a demodulation reference signal (DMRS), a phase track reference signal (PT-RS), or a cell reference signal (CRS). The reference signals listed above are merely examples, and shall not constitute any limitation on this application. This application does not exclude the possibility that other reference signals are defined in a future protocol to implement the same or similar function.

To facilitate understanding of the embodiments of this application, the CSI-RS is described in detail by example below. The CSI-RS is mainly used for downlink channel estimation corresponding to a physical antenna port. For example, a receiving apparatus (i.e. a UE) may perform channel estimation on each physical antenna port based on a CSI-RS sent by a transmitting apparatus ((i.e. a base station), to feedback channel state information (CSI) based on a channel estimation result. The CSI may include one or more of: a channel quality indicator (CQI), a precoding matrix indicator (PMI), and a layer indicator (LI), and a rank indicator (RI). The CSI is used to reconstruct or precode the downlink channel. In some implementations, a process in which the base station obtains CSI may include: sending, by the base station, reference signals to the UE; obtaining, by the UE, an estimated CSI value according to the received reference signals, selecting a precoding vector from a codebook according to the estimated CSI value, and feeding back an index of the precoding vector to the base station; and determining, by the base station, a CSI reconstruction value with reference to the index of the precoding vector. The CSI reconstruction value can be CSI closest to the true value of the CSI that can be obtained by the base station.

In an implementation, a transmitting apparatus maps a sequence of reference signals to certain physical resources, and transmits the reference signals over the certain physical resources, where the sequence of reference signals and the physical resources are known to both the transmitting apparatus and the receiving apparatus receiving the reference signals. Thus, the receiving apparatus could perform channel estimation based on the received reference signals.

Referring to FIG. 5, in some implementations, a process in which the base station obtains CSI may include: sending, by the base station, reference signals to the UE; obtaining, by the UE, an estimated CSI value according to the received reference signals, selecting a precoding vector from a codebook according to the estimated CSI value, and feeding back an index of the precoding vector to the base station; and determining, by the base station, a CSI reconstruction value with reference to the index of the precoding vector. The CSI reconstruction value can be CSI closest to the true value of the CSI that can be obtained by the base station.

The process of transmitting reference signals described below may be performed by a base station, or may be performed by a UE. The process of measuring a channel may be performed by the UE when the base station transmits the reference signals, and may be performed by the base station when the UE transmits the reference signals. For ease of description, an apparatus that transmits the reference signals is herein-after referred to as a transmitting apparatus and an apparatus that measures a channel based on the reference signals is herein-after referred to as a receiving apparatus.

### 3) Channel Interpolation

The channel interpolation is similar to the channel estimation, and the channel interpolation and the channel estimation are performed to construct a channel or reconstruct a channel. The difference is that the channel estimation refers to the process of reconstructing or restoring received signals to compensate for signal distortion caused by channel fading and noise, and the channel interpolation refers to the process of determining received signals of locations other than the signals resources locations. The following is illustrated with a diagram.

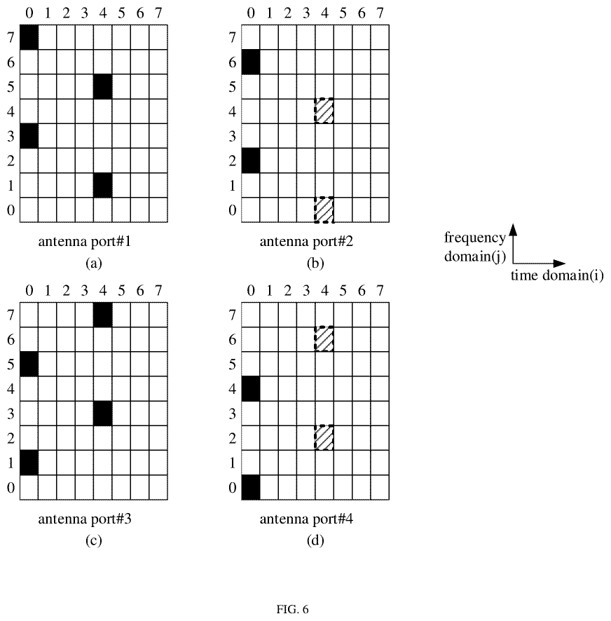

Referring to FIG. 6, an illustration of the channel estimation and the channel interpolation is shown. FIG. 6(a) and FIG. 6(c) are examples of the channel estimation, and FIG. 6(b) and FIG. 6(d) are examples of the channel interpolation. In FIG. 6, for brevity, (i,j) is used to indicate a location, where the i represents a time domain location, and the j represents a frequency domain location.

As shown in FIG. 6(a), a transmitting apparatus uses antenna port #1 to transmit reference signals on four locations as shown in a shaded part of FIG. 6(a), and correspondingly, a receiving apparatus receives the reference signals. The four locations are (0,3), (0,7), (4,1), and (4,5). A procedure during which the receiving apparatus obtains channel information of the four locations based on the reference signals could be referred to as the channel estimation.

As shown in FIG. 6(b), a transmitting apparatus uses antenna port #2 to transmit reference signals on two locations as shown in a shaded part of FIG. 6(b), and correspondingly, a receiving apparatus receives the reference signals. The two locations are (0,2) and (0,6). A procedure during which the receiving apparatus obtains channel information of other locations (e.g. (4,0) and (4,4)) based on the reference signals could be referred to as the channel interpolation. Specifically, the receiving apparatus obtains channel information of the two locations based on the reference signals, and the receiving apparatus obtains the channel information of the other locations based on the channel information of the two locations. The other locations could include locations other than the two locations in FIG. 6(b).

As shown in FIG. 6(c), a transmitting apparatus uses antenna port #3 to transmit reference signals on four locations as shown in a shaded part of FIG. 6(c), and correspondingly, a receiving apparatus receives the reference signals. The four locations are (0,1), (0,5), (4,3), and (4,7). A procedure during which the receiving apparatus obtains channel information of the four locations based on the reference signals could be referred to as the channel estimation.

As shown in FIG. 6(d), a transmitting apparatus uses antenna port #4 to transmit reference signals on two locations as shown in a shaded part of FIG. 6(d), and correspondingly, a receiving apparatus receives the reference signals. The two locations are (0,0) and (0,4). A procedure during which the receiving apparatus obtains channel information of other locations (e.g. (4,2) and (4,6)) based on the reference signals could be referred to as the channel interpolation. Specifically, the receiving apparatus obtains channel information of the two locations based on the reference signals, and the receiving apparatus obtains the channel information of the other locations based on the channel information of the two locations. The other locations could include locations other than the two locations in FIG. 6(b).

### 4) Assistance Information

The assistance information indicates a relationship between different channels. Specifically, a receiving apparatus receives reference signals, and performs channel estimation based on the reference signals to obtain first channel coefficients corresponding to a first channel; and the receiving apparatus could obtain second channel coefficients corresponding to a second channel based on the first channel coefficients and assistance information, where the assistance information indicates a relationship between the first channel and the second channel. Based on the foregoing technical solution, the receiving apparatus could obtain the second channel coefficients based on the first channel coefficients and the assistance information, and thus a transmitting apparatus does not need transmit reference signals corresponding to the second channel to obtain the second channel coefficients.

The channel coefficients represent one or more values of a channel matrix. For example, the receiving apparatus performs channel estimation based on the reference signals, and determines a matrix of the first channel based on a channel estimation result, and values of the matrix of the first channel could be referred to as the first channel coefficients.

In some embodiments, the assistance information may include: matrix based information, vector based information, tensor based information, and manifold information.

As described above, the assistance information and channel coefficients could be used to obtain other channel coefficients. There are many channel construct operations, and a receiving apparatus could obtain the other channel coefficients based on the channel coefficients and the assistance information by performing different channel construct operations. Therefore, which channel construct operation is performed to obtain the other channel coefficients becomes an urgent problem to be solved.

In view of this, the embodiments of this application provide a method to solve the problem. Specifically, a transmitting apparatus could indicate that assistance information is for a channel construct operation (for example, channel estimation and/or channel interpolation), and thus a receiving apparatus could perform the channel construct operation indicated by the transmitting apparatus based on the assistance information.

The following describes the embodiments of this application in detail with reference to the accompanying drawings.

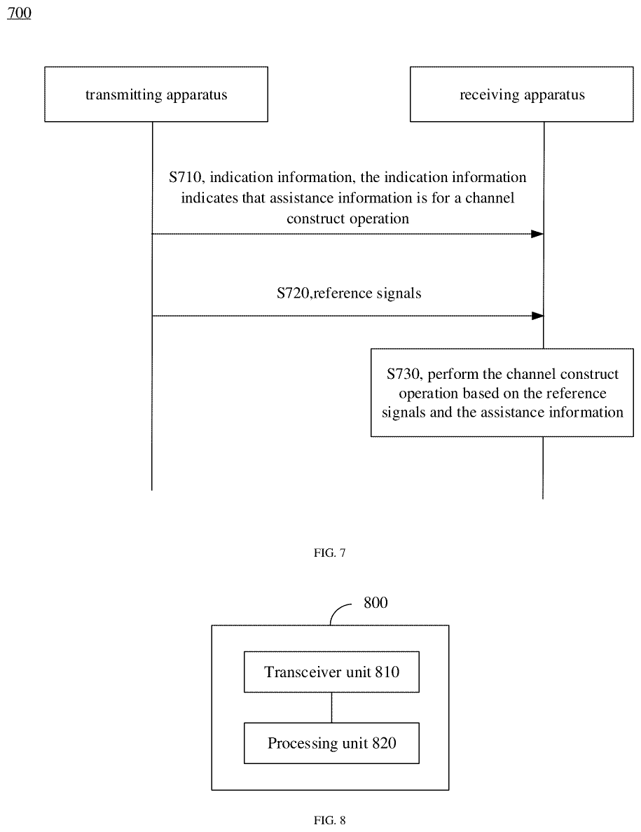

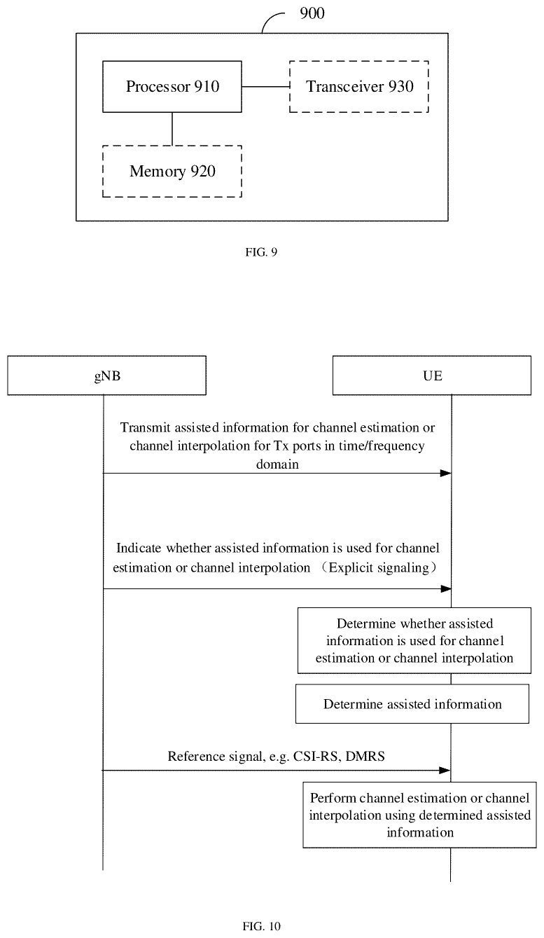

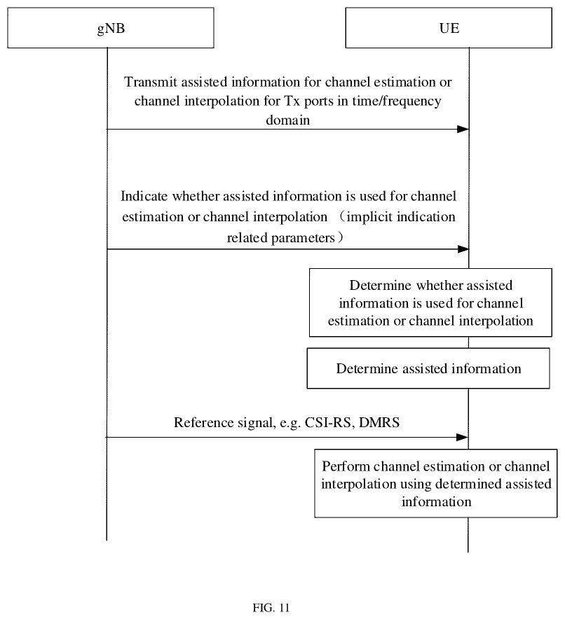

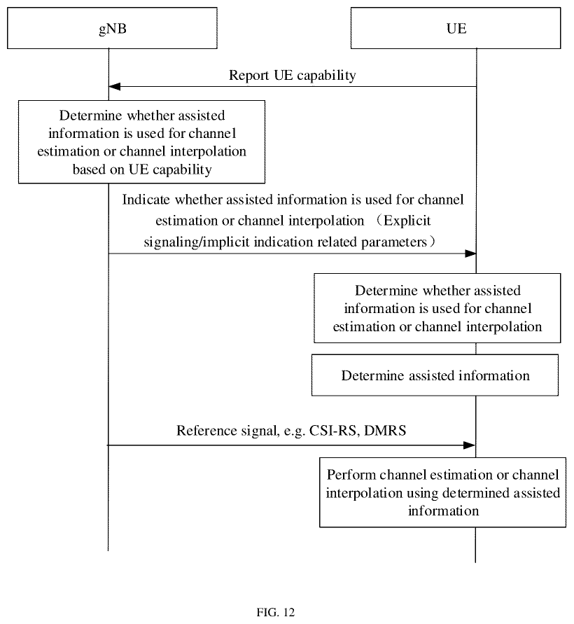

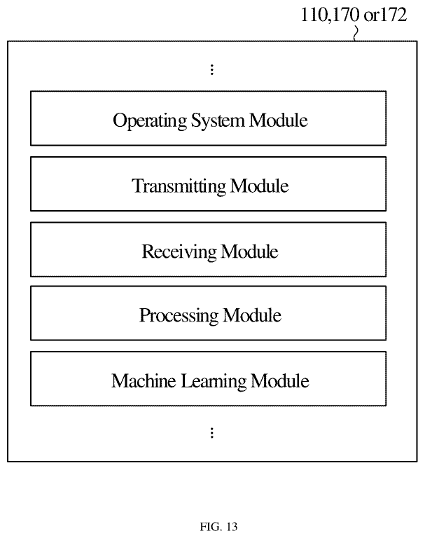

Referring to FIG. 7, a schematic flowchart of a communication method 700 according to an embodiment of this application is shown. The communication method 700 may be applied to the communication system 100 shown in FIG. 1.

At S710, a receiving apparatus receives indication information, the indication information indicates that assistance information is for a channel construct operation.

Correspondingly, a transmitting apparatus transmits the indication information.

The construct channel operation represents an operation related to constructing a channel or reconstructing a channel. In a possible implementation, the construct channel operation includes channel estimation and/or channel interpolation.

In a possible implementation, the indication information is carried in any one of medium access control-control element (MAC CE), radio resource control (RRC), or control information. If the receiving apparatus is a base station, and the transmitting apparatus is a UE, the control information could be uplink control information (UCI). If the receiving apparatus is a UE, and the transmitting apparatus is a base station, the control information could be downlink control information (DCI).

At S720, the receiving apparatus receives reference signals.

Correspondingly, the transmitting apparatus transmits the reference signals.

For an example, the receiving apparatus is a base station, and the transmitting apparatus is a UE. In this example, the reference signal is an uplink reference signal, e.g. SRS.

For another example, the receiving apparatus is a UE, and the transmitting apparatus is a base station. In this example, the reference signal is a downlink reference signal, e.g. CSI-RS.

At S730, the receiving apparatus performs the channel construct operation based on the reference signals and the assistance information.

For example, the receiving apparatus performs channel estimation based on the reference signals to obtain first channel coefficients corresponding to a first channel; and the receiving apparatus could obtain second channel coefficients corresponding to a second channel by performing the channel construct operation based on the first channel coefficients and the assistance information, where the assistance information indicates a relationship between the first channel and the second channel.

In a possible implementation, at S710, the indication information indicates that the assistance information is for the channel estimation, and at S730, the receiving apparatus performs the channel estimation based on the reference signals and the assistance information.

In another possible implementation, at S710, the indication information indicates that the assistance information is for the channel interpolation, and at S730, the receiving apparatus performs the channel interpolation based on the reference signals and the assistance information.

In another possible implementation, at S710, the indication information indicates that the assistance information is for the channel estimation and the channel interpolation, and at S730, the receiving apparatus performs the channel estimation and the channel interpolation based on the reference signals and the assistance information.

Based on the foregoing technical solution, the transmitting apparatus could indicate that assistance information is for a channel construct operation (for example, channel estimation and/or channel interpolation), and the receiving apparatus could perform the channel construct operation indicated by the transmitting apparatus based on the reference signals and the assistance information.

In a possible implementation, the receiving apparatus receives the assistance information. Correspondingly, the transmitting apparatus transmits the assistance information.

In another possible implementation, the receiving apparatus determines the assistance information by itself.

The indication information may be designed in any one of the following manners.

Manner #A: The indication information explicitly indicates that the assistance information is for channel construct operation.

In a possible implementation, the indication information is implemented by using one or more bits. Here are three examples.

### Example 1: The Indication Information is Implemented by Using One Bit

Specifically, for example, if a value of the one bit is “0”, the construct channel operation is the channel estimation, that is, the indication information indicates the assistance information is for the channel estimation; and if a value of the one bit is “1”, the construct channel operation is the channel interpolation, that is, the indication information indicates the assistance information is for the channel interpolation.

### Example 2: The Indication Information is Implemented by Using Two Bits

Specifically, for example, if a value of the two bits is “00”, the construct channel operation is the channel estimation, that is, the indication information indicates the assistance information is for the channel estimation; if a value of the two bits is “01”, the construct channel operation is the channel interpolation, that is, the indication information indicates the assistance information is for the channel interpolation; and if a value of the two bits is “10, the construct channel operation includes the channel estimation and the channel interpolation, that is, the indication information indicates the assistance information is for the channel estimation and the channel interpolation. For example, a value of the two bits “11” could be reserved.

### Example 3: The Indication Information is Implemented by Using Two Bits, and a Form of the Two Bits is a Bitmap

Specifically, for example, a most significant bit (MSB) of the bitmap indicates the channel estimation, and a least significant bit (LSB) of the bitmap indicates the channel interpolation. Assume that “1” denotes enable/activating. If a value of the bitmap is “01”, the construct channel operation is the channel interpolation, that is, the indication information indicates the assistance information is for the channel interpolation; if a value of the two bits bitmap is “10”, the construct channel operation is the channel estimation, that is, the indication information indicates the assistance information is for the channel estimation; and if a value of the bitmap is “11”, the construct channel operation includes the channel estimation and the channel interpolation, that is, the indication information indicates the assistance information is for the channel estimation and the channel interpolation.

### Example 1-Example 3 are Merely Examples, and this Embodiment of this Application is not Limited Thereto

Manner #B: The indication information implicitly indicates that the assistance information is for a channel construct operation.

In a possible implementation, the indication information includes a first parameter set of the assistance information, and the first parameter set has a first relationship with the channel construct operation. According to this implementation, the receiving apparatus could determine the channel construct operation based on the first parameter set of the assistance information and the first relationship.

The first relationship could be pre-defined, or received from the other apparatus. For example, the transmitting apparatus transmits the first relationship, and the receiving apparatus receives the first relationship.

For example, the first parameter set includes one or more of the following: a type of the assistance information, and a dimension of the assistance information. Here are two examples.

### Example 1: The First Parameter Set Includes the Type of the Assistance Information

Specifically, the type of the assistance information has the first relationship (relationship #1) with the channel construct operation, and the receiving apparatus could determine the channel construct operation based on the type of the assistance information and the relationship #1.

For example, the relationship #1 between the type of the assistance information and the channel construct operation is shown in the following Table 1.

TABLE 1

| the type of the | |
|---|---|
| assistance information | the channel construct operation |
| matrix based | channel estimation and/or channel interpolation |
| information | |
| vector based | channel estimation and/or channel interpolation |
| information | |
| tensor based | channel estimation and/or channel interpolation |
| information | |
| manifold information | channel interpolation |

For example, as shown in Table 1, if the type of the assistance information is any one of the following: the matrix based information, the vector based information, and the tensor based information, then the construct channel operation includes the channel estimation and/or the channel interpolation, that is, the indication information indicates the assistance information is for the channel estimation and/or the channel interpolation. If the type of the assistance information is the manifold information, then the construct channel operation is the channel interpolation, that is, the indication information indicates the assistance information is for the channel interpolation.

### Example 2: The First Parameter Set Includes the Dimension of the Assistance Information

Specifically, the dimension of the assistance information has the first relationship (relationship #2) with the channel construct operation, and the receiving apparatus could determine the channel construct operation based on the type of the assistance information and the relationship #2.

For example, the relationship #2 between the dimension of the assistance information and the channel construct operation is shown in the following Table 2. For brevity, the dimension of the assistance information could be referred to as dimension #1, and a dimension of a channel corresponding to the reference signals could be referred to as dimension #2.

TABLE 2

| the dimension #1 and | |
|---|---|
| the dimension#2 | the channel construct operation |
| the dimension#1 is | channel interpolation, or channel estimation and |
| larger than the | channel interpolation |
| dimension#2 | |
| the dimension#1 is | channel estimation |
| equal to the | |
| dimension#2 | |

For example, as shown in Table 2, if the dimension #1 is larger than the dimension #2, then the construct channel operation includes the channel interpolation, or the channel estimation and the channel interpolation, that is, the indication information indicates the assistance information is for the channel interpolation, or the channel estimation and the channel interpolation. If the dimension #1 is equal to the dimension #2, then the construct channel operation is the channel estimation, that is, the indication information indicates the assistance information is for the channel estimation.

In another possible implementation, the indication information includes a second parameter set of the assistance information, and the second parameter set has a second relationship with the channel construct operation. According to this implementation, the receiving apparatus could determine the channel construct operation based on the second parameter set of the assistance information and the second relationship.

The second relationship could be pre-defined, or received from the other apparatus. For example, the transmitting apparatus transmits the second relationship, and the receiving apparatus receives the second relationship.

For example, the second parameter set includes one or more of the following: a pattern density of the reference signals, and a type of the reference signals. There are two examples.

### Example 1: The Second Parameter Set Includes the Type of the Reference Signals

Specifically, the type of the reference signals has the second relationship (relationship #3) with the channel construct operation, and the receiving apparatus could determine the channel construct operation based on the type of the reference signals and the relationship #3.

For example, the relationship #3 between the type of the reference signals and the channel construct operation is shown in the following Table 3.

TABLE 3

| the type of the | |
|---|---|
| reference signals | the channel construct operation |
| DMRS | channel estimation and channel interpolation |
| CSI-RS | channel estimation |
| SRS | channel estimation |

For example, as shown in Table 3, if the type of the reference signals is DMRS, then the construct channel operation includes the channel estimation and the channel interpolation, that is, the indication information indicates the assistance information is for the channel estimation and the channel interpolation. If the type of the reference signals is the CSI-RS or the SRS, then the construct channel operation is the channel estimation, that is, the indication information indicates the assistance information is for the channel estimation.

### Example 2: The Second Parameter Set Includes the Pattern Density of the Reference Signals

Specifically, the pattern density of the reference signals has the second relationship (relationship #4) with the channel construct operation, and the receiving apparatus could determine the channel construct operation based on the pattern density of the reference signals and the relationship #4.

For example, the relationship #4 between the pattern density of the reference signals and the channel construct operation is shown in the following Table 4.

TABLE 4

| the pattern density of | |
|---|---|
| the reference signals | the channel construct operation |
| even | channel estimation or channel interpolation |
| dense | channel estimation or channel interpolation |
| uneven | channel estimation and channel interpolation |
| sparse | channel estimation and channel interpolation |

For example, as shown in Table 4, if the pattern density of the reference signals is even or dense, then the construct channel operation includes the channel estimation or the channel interpolation, that is, the indication information indicates the assistance information is for the channel estimation or the channel interpolation. If the pattern density of the reference signals is uneven or sparse, then the construct channel operation is the channel estimation and the channel interpolation, that is, the indication information indicates the assistance information is for the channel estimation and the channel interpolation.

In Table 4, the pattern density of the reference signals is defined as “even, dense, uneven, or sparse”, the pattern density of the reference signals also could be referred to as a threshold. For example, the “even” could be replaced with “≥a first threshold”, the “dense” could be replaced with “≥a second threshold”, the “uneven” could be replaced with “≤a third threshold”, and the “sparse” could be replaced with “≤a fourth threshold”.

The content of Table 1-Table 4 is merely an example, and this embodiment of this application is not limited thereto. For example, the relationship (the relationship #1, or the relationship #2, or the relationship #3, or the relationship #4) can take other forms.

In the method 700, in some embodiments, if the receiving apparatus is a UE, and the transmitting apparatus is a base station, the indication information could be generated by the base station determined based on UE capability.

In a possible implementation, the receiving apparatus transmits capability information indicating the UE capability. Correspondingly, the transmitting apparatus receives the capability information. And the transmitting apparatus could determine the indication information based on the capability information.

In a possible implementation, the capability information is carried in any one of MAC CE, RRC, or DCI. For example, the capability information is a UE report. Specifically, the receiving apparatus transmits the UE report indicating the UE capability.

Here are some detailed examples.

### Example 1: The Capability Information Indicates that UE Supports Channel Interpolation

Specifically, if the capability information indicates that the UE supports the channel interpolation, the UE could perform the channel interpolation without the assistance information, so the base station could determine the assistance information is for the channel estimation, and the base station transmits the indication information, and the indication information indicates the assistance information is for the channel estimation.

### Example 2: The Capability Information Indicates that UE does not Support Channel Interpolation

Specifically, if the capability information indicates that the UE does not support the channel interpolation, the UE could perform the channel interpolation with the assist of the assistance information, so the base station could determine the assistance information is for the channel interpolation, and the base station transmits the indication information, and the indication information indicates the assistance information is for the channel interpolation. Or, if the capability information indicates that the UE does not support the channel interpolation, the base station could determine the assistance information is for the channel interpolation and the channel estimation, and the base station transmits the indication information, and the indication information indicates the assistance information is for the channel interpolation and the channel estimation.

### Example 3: The Capability Information Indicates that UE Supports Channel Estimation

Specifically, if the capability information indicates that the UE supports the channel estimation, the UE could perform the channel estimation without the assistance information, so the base station could determine the assistance information is for the channel interpolation, and the base station transmits the indication information, and the indication information indicates the assistance information is for the channel interpolation.

### Example 4: The Capability Information Indicates that UE does not Support Channel Estimation

Specifically, if the capability information indicates that the UE does not support the channel estimation, the UE could perform the channel estimation with the assist of the assistance information, so the base station could determine the assistance information is for the channel estimation, and the base station transmits the indication information, and the indication information indicates the assistance information is for the channel estimation. Or, if the capability information indicates that the UE does not support the channel estimation, the base station could determine the assistance information is for the channel interpolation and the channel estimation, and the base station transmits the indication information, and the indication information indicates the assistance information is for the channel interpolation and the channel estimation.

In the embodiments of this application, “and/or” describes an association relationship between associated objects and represents that three relationships may exist. For example, A and/or B may represent the following three cases: only A exists, both A and B exist, and only B exists. The character “/” generally indicates an “or” relationship between the associated objects. “At least one” means one or more. “At least one of A and B”, similar to “A and/or B”, describes an association relationship between associated objects and represents that three relationships may exist. For example, at least one of A and B may represent the following three cases: only A exists, both A and B exist, and only B exists.

The methods according to embodiments of this application are described above in detail with reference to FIG. 7. The apparatuses provided in embodiments of this application are described below in detail with reference to FIGS. 8-9. Description of apparatus embodiments corresponds to the description of the method embodiments. Therefore, for content that is not described in detail, refer to the foregoing method embodiments. For brevity, details are not described herein again.

The communication method according to the embodiments of this application is described in detail above with reference to FIG. 7, and the transmitting apparatus and the receiving apparatus according to the embodiments of this application will be described in detail below with reference to FIGS. 8-9.

Referring to FIG. 8, a schematic block diagram of a communication apparatus according to an embodiment of this application is shown. The communication apparatus 800 includes a transceiver unit 810 and a processing unit 820. The transceiver unit 810 may implement a corresponding communication function, and the processing unit 810 is configured to perform data processing. The transceiver unit 810 may also be referred to as a communication interface or a communication unit.

In some embodiments, the communication apparatus 800 may further include a storage unit. The storage unit may be configured to store instructions and/or data. The processing unit 820 may read instructions and/or data in the storage unit, to enable the communication apparatus to implement the foregoing method embodiments.

The communication apparatus 800 may be configured to perform actions performed by the transmitting apparatus in the foregoing method embodiments. In this case, the communication apparatus 800 may be the transmitting apparatus or a component that can be configured in the transmitting apparatus. The transceiver unit 810 is configured to perform receiving/transmitting-related operations on the transmitting apparatus side in the foregoing method embodiments. The processing unit 820 is configured to perform processing-related operations on the transmitting apparatus side in the foregoing method embodiments.

Alternatively, the communication apparatus 800 may be configured to perform actions performed by the receiving apparatus in the foregoing method embodiments. In this case, the communication apparatus 800 may be the receiving apparatus or a component that can be configured in the receiving apparatus. The transceiver unit 810 is configured to perform receiving/transmitting-related operations on the receiving apparatus side in the foregoing method embodiments. The processing unit 820 is configured to perform processing-related operations on the receiving apparatus side in the foregoing method embodiments.

In a design, the communication apparatus 800 is configured to perform actions performed by the transmitting apparatus in the foregoing method embodiments.

In an implementation, the transceiver unit 810 is configured to transmit indication information, where the indication information indicates that assistance information is for channel estimation, and transmit reference signals for the channel estimation. In another implementation, the transceiver unit 810 is configured to transmit indication information, where the indication information indicates that assistance information is for channel interpolation, and transmit reference signals for the channel interpolation.

The communication apparatus 800 may implement steps or procedures performed by the transmitting apparatus in FIG. 7 according to embodiments of this application. The communication apparatus 800 may include units configured to perform the method performed by the transmitting apparatus in FIG. 7. In addition, the units in the communication apparatus 800 and the foregoing other operations and/or functions are separately used to implement corresponding procedures in FIG. 7.

In another design, the communication apparatus 800 is configured to perform actions performed by the receiving apparatus in the foregoing method embodiments.

In an implementation, the transceiver unit 810 is configured to receive indication information, where the indication information indicates that assistance information is for channel estimation; and receive reference signals; and the processing unit 820 is configured to perform the channel estimation based on the reference signals and the assistance information. In another implementation, the transceiver unit 810 is configured to receive indication information, where the indication information indicates that assistance information is for channel interpolation; and receive reference signals; and the processing unit 820 is configured to perform the channel interpolation based on the reference signals and the assistance information.

The communication apparatus 800 may implement steps or procedures performed by the receiving apparatus in FIG. 7 according to embodiments of this application. The communication apparatus 800 may include units configured to perform the method performed by the receiving apparatus in FIG. 7. In addition, the units in the communication apparatus 800 and the foregoing other operations and/or functions are separately used to implement corresponding procedures in FIG. 7.

A specific process in which the units perform the foregoing corresponding steps is described in detail in the foregoing method embodiments. For brevity, details are not described herein again.

Referring to FIG. 9, a schematic block diagram of another communication apparatus according to an embodiment of this application is shown. The communication apparatus 900 includes a processor 910. The processor 910 is coupled to a memory 920. The memory 920 is configured to store a computer program or instructions and/or data. The processor 910 is configured to execute the computer program or instructions and/or data stored in the memory 920, so that the methods in the foregoing method embodiments are executed.

In some embodiments, the communication apparatus 900 includes one or more processors 910.

In an example, as shown in FIG. 9, the communication apparatus 900 may further include the memory 920.

In some embodiments, the communication apparatus 900 may include one or more memories 920.

In an example, the memory 920 may be integrated with the processor 910, or disposed separately from the processor 910.

In an example, as shown in FIG. 9, the communication apparatus 900 may further include a transceiver 930, where the transceiver 930 is configured to receive and/or transmit a signal. For example, the processor 910 may be configured to control the transceiver 930 to receive and/or transmit a signal.

In a solution, the communication apparatus 900 is configured to perform the operations performed by the transmitting apparatus in the foregoing method embodiments.

For example, the processor 910 may be configured to perform a processing-related operation performed by the transmitting apparatus in the foregoing method embodiments, and the transceiver 930 may be configured to perform a receiving/transmitting-related operation performed by the transmitting apparatus in the foregoing method embodiments.

In another solution, the communication apparatus 900 is configured to perform the operations performed by the receiving apparatus in the foregoing method embodiments.

For example, the processor 910 may be configured to perform a processing-related operation performed by the receiving apparatus in the foregoing method embodiments, and the transceiver 930 may be configured to perform a receiving/transmitting-related operation performed by the receiving apparatus in the foregoing method embodiments.

An embodiment of this application further provides a computer-readable storage medium. The computer-readable storage medium stores computer instructions used to implement the method performed by the transmitting apparatus or the method performed by the receiving apparatus in the foregoing method embodiments.

For example, when the computer program is executed by a computer, the computer may be enabled to implement the method performed by the transmitting apparatus or the method performed by the receiving apparatus in the foregoing method embodiments.

An embodiment of this application further provides a computer program product including instructions. When the instructions are executed by a computer, the computer is enabled to implement the method performed by the transmitting apparatus or the method performed by the receiving apparatus in the foregoing method embodiments.

An embodiment of this application further provides a communication system. The communication system includes the transmitting apparatus and the receiving apparatus in the foregoing embodiments.

For explanations and beneficial effects of related content of any communication apparatus provided above, refer to a corresponding method embodiment provided above. Details are not described herein again.

The processor mentioned in embodiments of this application may be a central processing unit (CPU). The processor may further be another general-purpose processor, a digital signal processor (DSP), an application-specific integrated circuit (ASIC), a field programmable gate array (FPGA), or another programmable logic device, a discrete gate, a transistor logic device, a discrete hardware component, or the like. The general-purpose processor may be a microprocessor, or the processor may be any conventional processor or the like.

The memory mentioned in embodiments of this application may be a volatile memory or a non-volatile memory, or may include a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM). For example, the RAM may be used as an external cache. By way of example but not limitation, the RAM may include a plurality of forms such as the following: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should be further noted that the memory described in this specification is intended to include, but is not limited to, these memories and any other memory of a suitable type.

A person of ordinary skill in the art may be aware that, in combination with the examples described in embodiments disclosed in this specification, units and methods may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

It may be clearly understood by a person skilled in the art that, for the purpose of convenient and brief description, for a detailed working process of the foregoing apparatus and unit, refer to a corresponding process in the foregoing method embodiment. Details are not described herein again.

In the several embodiments provided in this application, the disclosed apparatuses and methods may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic forms, mechanical forms, or other forms.

The units described as separate parts may or may not be physically separate, and parts displayed as units may or may not be physical units, may be located in one position, or may be distributed on a plurality of network units. Some or all of the units may be selected based on an actual requirement to implement the solutions provided in this application.

In addition, function units in embodiments of this application may be integrated into one unit, or each of the units may exist alone physically, or two or more units may be integrated into one unit.

All or some of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, an SSD), or the like. For example, the usable medium may include but is not limited to any medium that can store program code, such as a USB flash drive, a removable hard disk, a ROM, a RAM, a magnetic disk, or an optical disc.

The foregoing description is merely a specific implementation of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

What is claimed is:

1. A method, comprising:
receiving indication information, wherein the indication information indicates that assistance information is for channel estimation or channel interpolation;
receiving reference signals; and
performing the channel estimation or the channel interpolation based on the reference signals and the assistance information.

2. The method according to claim 1, wherein the indication information is implemented by using one or more bits.

3. The method according to claim 1, wherein the indication information indicates that the assistance information is for channel estimation, the indication information comprises a first parameter set of the assistance information, and the first parameter set has a relationship with the channel estimation.

4. The method according to claim 1, wherein the indication information indicates that the assistance information is for channel interpolation, the indication information comprises a second parameter set of the assistance information, and the second parameter set has a relationship with the channel interpolation.

5. The method according to claim 3, wherein the first parameter set comprises one or more of the following: a type of the assistance information, or a dimension of the assistance information.

6. A method, comprising:
transmitting indication information, wherein the indication information indicates that assistance information is for channel estimation or channel interpolation; and
transmitting reference signals for the channel estimation or the channel interpolation.

7. The method according to claim 6, wherein the indication information is implemented by using one or more bits.

8. The method according to claim 6, wherein the indication information indicates that the assistance information is for channel estimation, the indication information comprises a first parameter set of the assistance information, and the first parameter set has a relationship with the channel estimation.

9. The method according to claim 6, wherein the indication information indicates that assistance information is for channel interpolation, the indication information comprises a second parameter set of the assistance information, and the second parameter set has a relationship with the channel interpolation.

10. The method according to claim 8, wherein the first parameter set comprises one or more of the following: a type of the assistance information, or a dimension of the assistance information.

11. An apparatus, comprising:
at least one processor coupled with at least one memory storing one or more instructions that are capable of being run on the at least one processor, wherein when the one or more instructions are run, the apparatus is enabled to:
receive indication information, wherein the indication information indicates that assistance information is for channel estimation or channel interpolation;
receive reference signals; and
perform the channel estimation or the channel interpolation based on the reference signals and the assistance information.

12. The apparatus according to claim 11, wherein the indication information is implemented by using one or more bits.

13. The apparatus according to claim 11, wherein the indication information indicates that assistance information is for channel estimation, the indication information comprises a first parameter set of the assistance information, and the first parameter set has a relationship with the channel estimation.

14. The apparatus according to claim 11, wherein the indication information indicates that assistance information is for channel interpolation, the indication information comprises a second parameter set of the assistance information, and the second parameter set has a relationship with the channel interpolation.

15. The apparatus according to claim 13, wherein the first parameter set comprises one or more of the following: a type of the assistance information or a dimension of the assistance information.

16. An apparatus, comprising:
at least one processor coupled with at least one memory storing one or more instructions that are capable of being run on the at least one processor, wherein when the one or more instructions are run, the apparatus is enabled to:
transmit indication information, wherein the indication information indicates that assistance information is for channel estimation or channel interpolation; and
transmit reference signals for the channel estimation or the channel interpolation.

17. The apparatus according to claim 16, wherein the indication information is implemented by using one or more bits.

18. The apparatus according to claim 16, wherein the indication information indicates that assistance information is for channel estimation, the indication information comprises a first parameter set of the assistance information, and the first parameter set has a relationship with the channel estimation.

19. The apparatus according to claim 16, wherein the indication information indicates that assistance information is for channel interpolation, the indication information comprises a second parameter set of the assistance information, and the second parameter set has a relationship with the channel interpolation.

20. The apparatus according to claim 18, wherein the first parameter set comprises one or more of the following: a type of the assistance information or a dimension of the assistance information.
